(19) United States
(12) Patent Application Publication
(10) Pub. No.: US 2005/0050533 A1
(43) Pub. Date: Mar. 3, 2005

(54) Optimizing compiler

(75) Inventors: Akira Koseki, Sagamihara-shi (JP); Hideaki Komatsu, Yokohama-shi (JP)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 10/929,950

(22) Filed: Aug. 30, 2004

(30) Foreign Application Priority Data
Sep. 2, 2003 (JP) 2003-309675

(51) Int. Cl. G06F 9/45; G06F 9/44

(52) U.S. Cl. 717/158; 717/140; 717/130

(57) ABSTRACT

Compiler for optimizing a load instruction in a program, including: executable range detecting means for detecting executable range of load instruction in execution paths tracing back execution procedures from a target load, where the range can hold data read by the load instruction into register and transmit data to execution position of target load instruction when load instruction is executed; instruction generating means for generating a precedent load instruction, executed prior to target load instruction in executable range, within the executable range for each of the execution paths when the precedent load instruction for reading the same data from the same address as the target load instruction is absent; and instruction replacing means for deleting the target load instruction and replacing an instruction using the data read by the target load instruction with an instruction using data which are read by the precedent load instruction.

### FIELD OF THE INVENTION

The present invention relates to an optimizing compiler, a compiling method, a compiler program, and a recording medium. Specifically, the present invention relates to an optimizing compiler, a compiling method, a compiler program, and a recording medium, which delete a redundant instruction.

### BACKGROUND OF THE INVENTION

In recent years, operating speed of a central processing unit of a computer becomes faster due to technological innovation. For this reason, time required for the central processing unit to read a register is being increased relative to time required for memory access. Therefore, to improve processing speed for an entire program, it becomes more important to reduce a memory access amount by holding variable values, used in the program, in the register to the utmost extent.

The following documents are considered:
[Non-patent document 1] D. Bernstein, D. Q. Goldin, M. C. Golumbic, H. Krawczyk, Y. Mansour, I. Nahshon, and R. Y. Pinter. Spill code minimization techniques for optimizing compilers. In Proceedings of the ACM SIGPLAN 1989 Conference on Programming Language Design and Implementation, pages 258-263, 1989.
[Non-patent document 2] P. Briggs, K. D. Cooper, and L. Torczon. Rematerialization. In Proceedings of the ACM SIGPLAN 1992 Conference on Programming Language Design and Implementation, pages 311-321, 1992.
[Non-patent document 3] S. Kurlander and C. Fisher. Zero-cost range splitting. In Proceedings of the ACM SIGPLAN 1994 Conference on Programming Language Design and Implementation, pages 257-265, 1994.
[Non-patent document 4] P. Kolte and M. J. Harrold. Load/store range analysis for global register allocation. In Proceedings of the ACM SIGPLAN 1993 Conference on Programming Language Design and Implementation, pages 268-277, 1993.
[Non-patent document 5] P. Bergner, P. Dahl, D. Engebretsen, and M. O'Keefe. Spill code minimization via interference region spilling. In Proceedings of the ACM SIGPLAN 1997 Conference on Programming Language Design and Implementation, pages 287-295, 1997.
[Non-patent document 6] R. Gupta and R. Bodik. Register pressure sensitive redundancy elimination. In Proceedings of the 8th International Conference on Compiler Construction, LNCS 1575, pages 107-121, 1999.
[Non-patent document 7] J. Knoop, O. Ruthing, and B. Steffen. Optimal code motion: theory & practice. ACM TOPLAS, 18(3): 300-324, 1996.

A conventional optimizing compiler has a register allocation function for efficiently allocating variables in a target program targeted for optimization to a register in a central processing unit so as to make the whole processing more efficient by reducing the memory access amount (see Non-patent documents 1 to 5). Moreover, the optimizing compiler causes the register to hold the variable values allocated thereto. Meanwhile, the optimizing compiler causes a memory to store a variable value which is judged as unallocatable to the register, by the register allocation function, and generates an instruction to read such a variable value from the memory every time when reference is made thereto.

Moreover, when a plurality of instructions are redundant for mutually performing the same processing, the conventional optimizing compiler applies a redundancy elimination technique to improve efficiency of the entire processing by deleting at least part of the plurality of instructions (see Non-patent document 7). Moreover, there is also proposed a controlling technique to allocate as many variables as possible to the register in the process of applying the redundancy elimination technique (see Non-patent document 6).

However, there is a case where a partially usable register still exists even when the register allocation function is applied. Even in this case, it is inefficient to read the variable value, which was once judged as unallocatable to the register, invariably from the memory. Meanwhile, there is a case where a variable which is not allocated to the register even when the technique in Non-patent document 6 is applied.

### SUMMARY OF THE INVENTION

To resolve the foregoing problems, an aspect of the present invention is to provide an optimizing compiler for optimizing a load instruction to read data from a memory into a register in a target program targeted for optimization, which includes: executable range detecting means for detecting an executable range of a load instruction in each of all execution paths reachable by tracing back execution procedures from a target load instruction targeted for optimization in the target program, the executable range being capable of holding the data read by the load instruction into the register and transmitting the data to an execution position of the target load instruction when the load instruction is executed; instruction generating means for generating a precedent load instruction, which is to be executed prior to the target load instruction in the executable range, within the executable range for each of the execution paths when the precedent load instruction for reading the same data from the same address as the target load instruction is absent; and instruction replacing means for deleting the target load instruction and replacing an instruction using the data read by the target load instruction with an instruction using data which are read by the precedent load instruction, held in the register, and propagated therefrom.

In other aspects of the present invention, there are also provided a compiling method using the optimizing compiler, a compiler program for causing a computer to function as the optimizing compiler, and a recording medium recording the compiler program. According to the present invention, it is possible to make reference to variable values efficiently.

### BRIEF DESCRIPTION OF THE DRAWINGS

For a more complete understanding of the present invention and the advantages thereof, reference is now made to the following description taken in conjunction with the accompanying drawings.

FIG. 1 is a functional block diagram of an optimizing compiler 10.

FIG. 2 is a view showing an operation flow of the optimizing compiler 10.

FIG. 3 is an operational flow showing details of S240 in FIG. 2.

FIG. 4 is a view for explaining the processing of S310 in FIG. 3.

FIG. 5 is an operation flow showing details of S250 in FIG. 2.

FIGS. 6A to 6C show a first application example of an embodiment of the present invention. Specifically, FIG. 6A shows an example of a target program in which variables are allocated to registers by register allocating means 100, FIG. 6B shows an example of the target program in which spill-in instructions are generated by spill-in instruction generating means 110, and FIG. 6C shows a resultant program which is a result of optimization by the optimizing compiler 10 according to the embodiment.

FIGS. 7A to 7C show a second application example of the embodiment of the present invention. Specifically, FIG. 7A shows an example of a target program in which variables are allocated to registers by the register allocating means 100, FIG. 7B shows an example of the target program in which spill-in instructions are generated by the spill-in instruction generating means 110, and FIG. 7C shows a resultant program which is a result of optimization by the optimizing compiler 10 according to the embodiment.

FIGS. 8A to 8C show a third application example of the embodiment of the present invention. Specifically, FIG. 8A shows an example of a target program prior to optimization, FIG. 8B shows an example of the target program in which spill-in instructions are generated by the spill-in instruction generating means 110, and FIG. 8C shows a resultant program which is a result of optimization by the optimizing compiler 10 according to the embodiment.

FIG. 9 shows an example of a hardware configuration of a computer functioning as the optimizing compiler 10.

### DETAILED DESCRIPTION OF THE INVENTION

The present invention provides methods and systems for an optimizing compiler for optimizing a load instruction to read data from a memory into a register in a target program targeted for optimization. An example compiler includes: executable range detecting means for detecting an executable range of a load instruction in each of all execution paths reachable by tracing back execution procedures from a target load instruction targeted for optimization in the target program, the executable range being capable of holding the data read by the load instruction into the register and transmitting the data to an execution position of the target load instruction when the load instruction is executed; instruction generating means for generating a precedent load instruction, which is to be executed prior to the target load instruction in the executable range, within the executable range for each of the execution paths when the precedent load instruction for reading the same data from the same address as the target load instruction is absent; and instruction replacing means for deleting the target load instruction and replacing an instruction using the data read by the target load instruction with an instruction using data which are read by the precedent load instruction, held in the register, and propagated therefrom.

The present invention also provides a compiling method using the optimizing compiler, a compiler program for causing a computer to function as the optimizing compiler, and a recording medium recording the compiler program.

Hereinafter, the present invention will be described by way of an advantageous embodiment. It should be noted, however, that the following embodiment does not limit the invention according to the appended claims and that an entire combination of characteristics described in the embodiment is not always indispensable for a solution of the present invention.

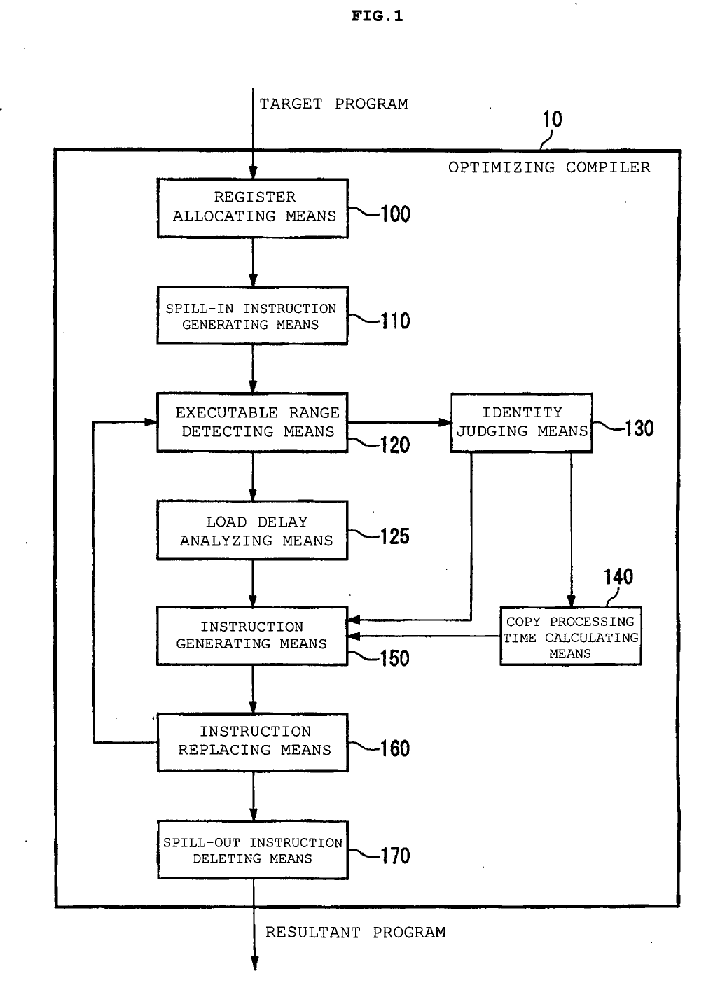

FIG. 1 is a functional block diagram of an optimizing compiler 10. An object of the optimizing compiler 10 is to optimize a load instruction for reading data from a memory in a target program targeted for optimization. The optimizing compiler 10 includes register allocating means 100, a spill-in instruction generating means 110, executable range generating means 120, load delay analyzing means 125, identity judging means 130, copy processing time calculating means 140, instruction generating means 150, instruction replacing means 160, and spill-out instruction deleting means 170 which is an example of store instruction deleting means.

Upon receipt of a target program, the register allocating means 100 performs register allocation processing to allocate a variable to a register, and transmits the target program, which is the result of the processing, to the spill-in instruction generating means 110. Upon receipt thereof, the spill-in instruction generating means 110 generates a spill-in instruction concerning each variable, which is judged as unallocatable to the register by the register allocating means 100, to load the variable value from a memory prior to each instruction using the variable value, and transmits the target program, which is the result of the generation processing, to the executable range generating means 120.

Here, the target program is an intermediate representation which represents the program targeted for optimization in the optimizing compiler. The target program is a bytecode in the Java (trademark) language, the register transfer language (RTL), or a quadruplet representation, for example. Instead, the target program may be a source code of the program. Moreover, the variable is not limited to the variable per se in the source code; the variable may be a lifetime of the value in the target program, for example.

Moreover, the register is not limited to all registers usable in the central processing unit for executing the target program. The register only needs to be a register group, which is predetermined by specifications such as an operating system of an information processing apparatus or a programming language and is authorized to be used in the target program. For example, it is not necessary to include a register which may be used by a library program to be called up from the target program and the like, and the contents of which may be changed.

In terms of the received target program, the executable range detecting means 120 performs the following processing on any variable unallocatable to the register, while each of a plurality of spill-in instructions for reading the variable value from the memory is set to a target spill-in instruction targeted for optimization.

First, the executable range generating means 120 detects an executable range of a load instruction in each of all execution paths reachable by tracing back execution procedures from the target spill-in instruction, where the executable range can hold the data read by the load instruction into the register and transmit the data to an execution position of the target spill-in instruction when the load instruction is executed.

Next, for a plurality of target spill-in instructions where any of the executable ranges overlap each other, the executable range generating means 120 detects a range of an execution position supposed to generate a precedent load instruction for reading the same data from the same address as the plurality of target spill-in instructions instead of the plurality of target spill-in instructions, which also represents the range that satisfies computational optimality concerning the plurality of target spill-in instructions. Moreover, the executable range generating means 120 detects a position, in the range, satisfying the computational optimality, which satisfies lifetime optimality where a lifetime of the value read by the precedent load instruction becomes smallest. Thereafter, the executable range generating means 120 transmits the target program together with a detection result to the load delay analyzing means 125 and the identity judging means 130.

Upon receipt of the detection result from the executable range generating means 120, the load delay analyzing means 125 analyzes required processing time which is processing time required for executing another instruction from the position satisfying the lifetime optimality to the execution position of the instruction using the data to be read by the precedent load instruction. Subsequently, the load delay analyzing means 125 analyzes load processing time required from starting execution of the precedent load instruction until completion of reading the data. Thereafter, when the required processing time is shorter than load processing time, the load delay analyzing means 125 detects an execution position of execution, prior to the position satisfying the lifetime optimality by the time calculated by subtracting the required processing time from the load processing time, as a generation position to generate the precedent load instruction. Thereafter, the load delay analyzing means 125 transmits a detection result to the instruction generating means 150.

When the computational optimality is satisfied, the identity judging means 130 checks, on each of the target spill-in instructions, whether or not it is possible to identically set a register as reading targets of all the precedent load instructions to be executed prior to the target spill-in instructions in the executable ranges of the target spill-in instructions. Then, the identity judging means 130 notifies the copy processing time calculating means 140 and the instruction generating means 150 of the judgment result.

Upon receipt of the notice from the identity judging means 130, when the identity judging means 130 judges that it is not possible to identically set the register, the copy processing time calculating means 140 calculates copy processing time required for copying the data among the registers in the case of not setting the register identically, and additional instruction processing time which is processing time for an additional load instruction in comparison with the case of satisfying the computational optimality when setting the register identically. Thereafter, the copy processing time calculating means 140 transmits the calculation result to the instruction generating means 150.

When there is not a precedent load instruction of the target spill-in instruction in the executable range of each of the execution paths, the instruction generating means 150 generates the precedent load instruction in the executable range by the following processing.

First, when the identity judging means 130 judges that it is possible to identically set the register or when the additional instruction processing time calculated by the copy processing time calculating means 140 is shorter than the copy processing time, the instruction generating means 150 generates the precedent load instruction in an execution position satisfying the computational optimality and the lifetime optimality.

On the contrary, when the identity judging means 130 judges that it is not possible to identically set the register and when the additional instruction processing time calculated by the copy processing time calculating means 140 is longer than the copy processing time, the instruction generating means 150 generates the precedent load instruction in a position, in the executable range, where the computational optimality is not satisfied and where it is possible to identically set the register as the reading targets of the respective precedent load instructions. Then, the instruction generating means 150 transmits the target program resulted from performing the generation processing to the instruction replacing means 160.

Here, the range satisfying the computational optimality is a range where the number of execution of the spill-in instructions in the entire target program is optimized by generating the load instruction, for example. The range satisfying the computational optimality is an overlapping range in each execution path for a first target spill-in instruction, where an executable range of the execution path and at least part of an executable range in a second target spill-in instruction overlap each other, for example. In other words, when there is not a precedent load instruction in the overlapping range, the instruction generating means 150 can delete not only the first spill-in instruction but also the second spill-in instruction, by generating the precedent load instruction in the overlapping range.

The instruction replacing means 160 deletes the respective target spill-in instructions which are set to be executed after the precedent load instruction, and replaces the instruction using the data read by the target spill-in instruction with an instruction using data to be read by the precedent load instruction, to be held in the register and to be propagated therefrom. Moreover, when the processing is completed for all the variables judged as unallocatable by the register allocating means 100, the instruction replacing means 160 transmits the target program to the spill-out instruction deleting means 170. When the processing is not completed for all the variables judged as unallocatable by the register allocating means 100, the instruction replacing means 160 transmits the target program to the executing range generating means 120.

When the target spill-in instructions are deleted by the instruction replacing means 160, the spill-out instruction deleting means 170 deletes a store instruction for writing data which are read only by the target spill-in instruction and are not read by the generated precedent load instruction. The spill-out instruction deleting means 170 outputs the target program resulted from the deletion processing as a resultant program resulted from compilation.

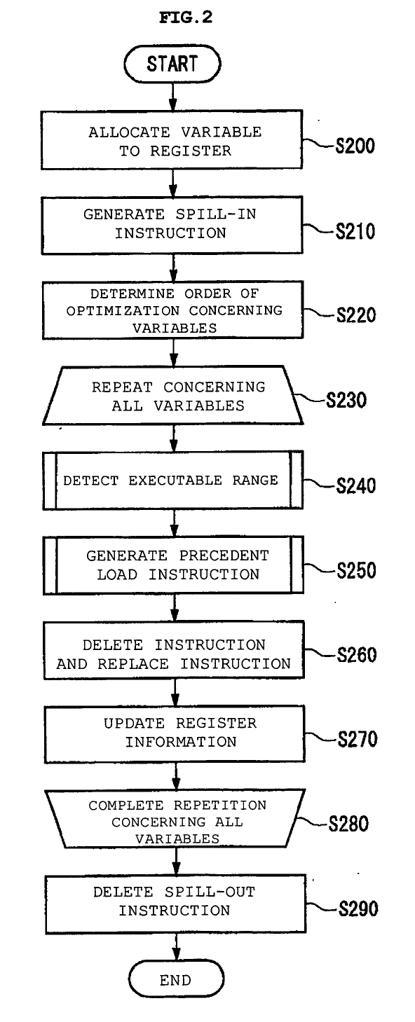

FIG. 2 is a view showing an operation flow of the optimizing compiler 10. First, the register allocating means 100 performs the register allocation processing, which allocates the variable to the register, on the target program (S200). For example, the register allocating means 100 may perform the register allocation processing according to the technique disclosed in Non-patent document 2. Thereafter, the spill-in instruction generating means 110 generates the spill-in instruction, for each variable judged as unallocatable to the register by the register allocating means 100, for reading the variable value from the memory into the register prior to each instruction using the variable value (S210).

The executable range detecting means 120 determines the order of optimization for the plurality of variables judged as unallocatable to the register by the register allocating means 100 (S220). For example, the executable range generating means 120 may determine the order so as to optimize the variables in descending order of the frequency of reference. Moreover, based on this order, the executable range generating means 120 repeats the following processing for the respective variables judged as unallocatable to the register (S230).

The executable range generating means 120 detects the executable range of the load instruction in each of all the execution paths reachable by tracing back the execution procedures from each target spill-in instruction of the plurality of target spill-in instructions for reading the variable values from the memory, where the executable range can hold the data read by the load instruction into the register and transmit the data to the execution position of the target spill-in instruction when the load instruction is executed (S240).

Moreover, when there is not a precedent load instruction in the executable range of each of the execution paths, the instruction generating means 150 generates the precedent load instruction in the executable range (S250). Subsequently, the instruction replacing means 160 deletes the target spill-in instruction and replaces the instruction using the data read by the target spill-in instruction with the instruction using the data to be read by the precedent load instruction, to be held in the register, and to be propagated therefrom (S260). For example, when the plurality of precedent load instructions in the plurality of execution paths read the data into a common register which is common to one another, the instruction replacing means 160 replaces the instruction using the data read by the target spill-in data with an instruction using the data held in the common register. Moreover, when the registers of the reading target are not identical with the plurality of precedent load instructions in the plurality of execution paths, the instruction replacing means 160 further generates an instruction for copying the data among the registers.

Subsequently, upon receipt of the results of generating the precedent load instruction and deleting the target spill-in instruction, the instruction replacing means 160 updates information concerning conditions of use of the registers (S270). The optimizing compiler 10 repeats the above-described processing for all the variables judged as unallocatable to the register by the register allocating means 100 (S280).

When the target spill-in instructions are deleted by the instruction replacing means 160, the spill-out instruction deleting means 170 deletes the store instruction for writing the data which are read only by the target spill-in instruction and are not read by the generated precedent load instruction. Then the spill-out instruction deleting means 170 outputs the target program resulted from the deletion processing as the resultant program resulted from compilation (S290).

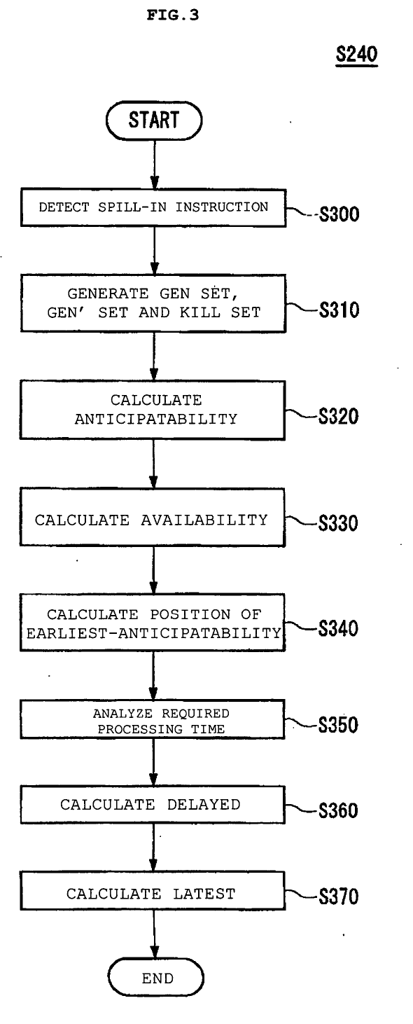

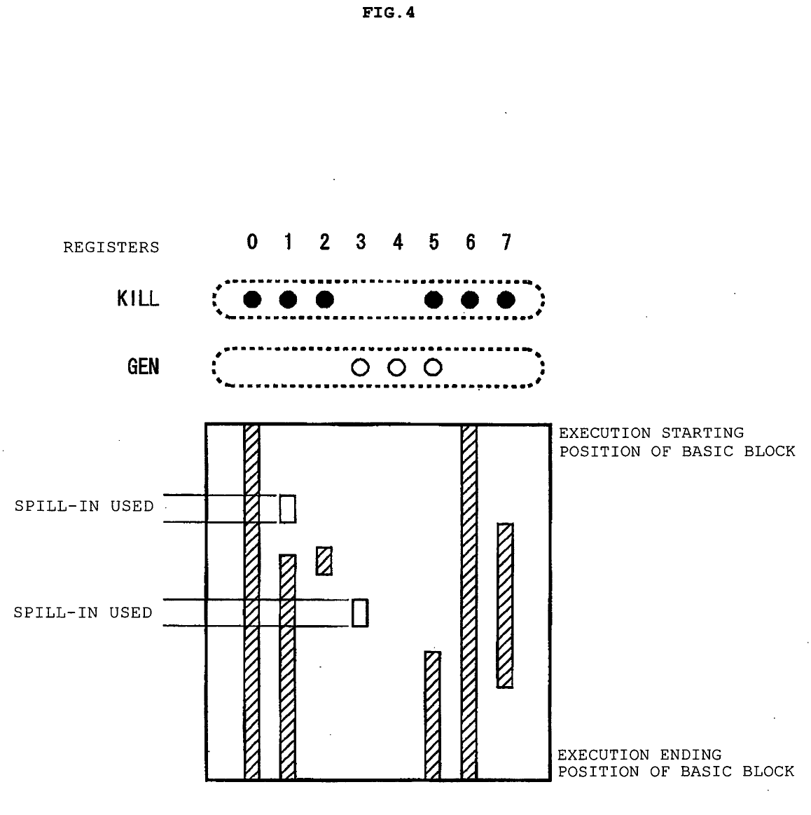

FIG. 3 is an operation flow showing details of S240 in FIG. 2. FIG. 4 is a view for explaining the processing of S310 in FIG. 3. The executable range generating means 120 detects the spill-in instruction generated by the spill-in instruction generating means 110 in each basic block of the target program (S300). Thereafter, the executable range generating means 120 generates the following three sets for each basic block, for the spill-in instruction in the target program.

(1) GEN Set

In terms of each spill-in instruction in the basic block, the executable range generating means 120 finds a set of registers not allocated to the variables by the register allocating means 100 in the range from an execution starting position of the basic block to the execution position of the spill-in instruction. However, the use of the register by the spill-in instruction itself is not included therein. Thereafter, the executable range generating means 120 generates a product set of the sets in each of the plurality of spill-in instructions in the basic block, as a GEN set. Here, when there is the spill-out instruction for writing in the same address as the address from which the target spill-in instruction reads the data, the executable range generating means 120 generates the GEN set regarding the range, in the basic block, to be executed prior to the spill-out instruction.

For example, in the example of FIG. 4, the executable range generating means 120 generates the set of registers not allocated to the variables, in the range until an execution position of a first spill-in instruction, as {Register 1, Register 2, Register 3, Register 4, Register 5, Register 7}. Then, the executable range generating means 120 generates the set of registers not allocated to the variables, in the range until an execution position of a second spill-in instruction, as {Register 3, Register 4, Register 5}. Accordingly, the executable range generating means 120 generates {Register 1, Register 2, Register 3, Register 4, Register 5, Register 7} ∩ [intersection] {Register 3, Register 4, Register 5} as the GEN set.

(2) GEN′ Set

In terms of each spill-in instruction in the basic block, the executable range generating means 120 finds a set of registers not allocated to the variables by the register allocating means 100 in the range from the execution position of the spill-in instruction to an execution ending position of the basic block. Thereafter, the executable range generating means 120 generates a product set of the sets, in each of the plurality of spill-in instructions in the basic block, as a GEN′ set. Here, when there is the spill-out instruction for writing in the same address as the address from which the target spill-in instruction reads the data, the executable range generating means 120 generates the GEN′ set regarding the range, in the basic block, to be executed after the spill-out instruction.

(3) KILL Set

The executable range generating means 120 generates a set of registers not allocated to the variables by the register allocating means 100 consistently, in the basic block. However, the use of the register by the spill-in instruction itself is not included therein. Thereafter, the executable range generating means 120 generates a complementary set of the generated set, as a KILL set. Here, when there is the spill-out instruction for writing in the same address as the address from which the target spill-in instruction reads the data, the executable range generating means 120 generates a set of all the registers as the KILL set.

For example, in each of Registers 1 to 7 in FIG. 4, the ranges already allocated to the variables by the register allocating means 100 are indicated with shaded portions. In this example, the executable range generating means 120 generates {Register 3, Register 4) as the set of registers not allocated to the variables consistently, in the basic block. Therefore, the executable range generating means 120 generates {Register 0, Register 1, Register 2, Register 5, Register 6, Register 7} as the KILL set.

The GEN set, the GEN′ set, and the KILL set in an nth basic block will be here in after referred to as GEN(n), GEN′ (n), and KILL(n), respectively.

Subsequently, for each executing position x (such as the execution starting position or the execution ending position of a certain basic block) of the target program, the executable range generating means 120 calculates totally-anticipatability concerning a computation e, which indicates whether or not the computation e (such as the spill-in instruction) exists in all the execution paths from the execution position x to an ending position of the target program (S320).

Specifically, the executable range generating means 120 calculates the totally-anticipatability by resolving the following data flow equations (1). In the equations, a set of registers satisfying the totally-anticipatability in the execution starting position of the nth basic block is expressed as ANTᵢₙ(n) when the spill-in instruction selects the registers as the reading targets, and a set of registers satisfying the totally-anticipatability in the execution ending position of the nth basic block is expressed as ANTₒᵤₜ(n) when the spill-in instruction selects the registers as the reading targets.

$$\text{[Equations 1]} \begin{matrix}{ANT}_{i n} ( n ) \text{:} = \{ \begin{matrix}ANT ( n ) - KILL ( n ) & if ANT ( n ) - KILL ( n ) \neq ϕ \\ GEN ( n ) & otherwise . \end{matrix} \\ {ANT}_{ out} ( n ) \text{:} = \{ \begin{matrix}ϕ & if n is end , \\ I {ANT}_{i n ( m )} & otherwise .\end{matrix}\end{matrix} \qquad ( 1 )$$

However, a set of basic blocks which can be executed subsequent to the nth basic block will be expressed as succ(n).

Subsequently, for each executing position x of the target program, the executable range generating means 120 calculates totally-availability concerning the computation e, which indicates whether or not the computation e exists in all the execution paths from the execution starting position of the target program to the execution position x (S330).

Specifically, the executable range generating means 120 calculates the totally-availability by resolving the following data flow equations (2). In the equations, a set of registers satisfying the totally-availability in the execution starting position of the nth basic block is expressed as AVLᵢₙ(n) when the spill-in instruction selects the registers as the reading targets, and a set of registers satisfying the totally-availability in the execution ending position of the nth basic block is expressed as AVLₒᵤₜ(n) when the spill-in instruction selects the registers as the reading targets.

$$\text{[Equations 2]} \begin{matrix}{ANT}_{out} ( n ) \text{:} = \{ \begin{matrix}{AVL}_{i n} ( n ) - KILL ( n ) & if {ANT}_{i n} ( n ) - KILL ( n ) \neq ϕ , \\ {GEN}^{′} ( n ) & otherwise . \end{matrix} \\ {ANT}_{i n} ( n ) \text{:} = \{ \begin{matrix}ϕ & if n is start , \\ I {ANT}_{i n ( m )} & otherwise .\end{matrix}\end{matrix} \qquad ( 2 )$$

However, a set of basic blocks which can be executed prior to the nth basic block will be expressed as pred(n).

Moreover, the executable range generating means 120 calculates an execution position with the totally-anticipatability and without the totally-availability in the computation e as a position satisfying earliest-anticipatability. Specifically, the executable range generating means 120 calculates the earliest-anticipatability by resolving the following equations (3) (S340).

$$[ Equations 3 ] \\ \begin{matrix}E AR - {ANT}_{i n} ( n ) \text{:} = {ANT}_{i n} ( n ) ϕ ⋀ {\sum }_{m ∈ pred ( n )}^{} ( {ANT}_{out} ( m ) \\ = ϕ ⋀ {ANT}_{i n} ( n ) ⋂ {AVL}_{out} ( m ) \\ = ϕ ) \\ EAR - {ANT}_{out} ( n ) \text{:} = {ANT}_{out} ( n ) \\ \neq ϕ ⋀ {ANT}_{out} ( n ) - KILL ( n ) \\ = ϕ\end{matrix} \qquad ( 3 )$$

Subsequently, the load delay analyzing means 125 analyzes the required processing time which is the processing time required for executing another instruction from the starting position of each basic block satisfying the totally-anticipatability to the execution position of the instruction using the data to be read by the spill-in instruction (S350). Then, the load delay analyzing means 125 calculates LAT-LOC(n), which is the time obtained by subtracting the analyzed required processing time from the load processing time required from starting execution of the spill-in instruction until completion of data reading.

Here, the processing time to be analyzed by the load delay analyzing means 125 may be the number of execution cycles, for example. That is, the load delay analyzing means 125 may analyze the number of execution cycles required for executing another instruction from the starting position of each basic block satisfying the totally-anticipatability to the execution position of the instruction using the data to be read by the spill-in instruction, as the required processing time. Similarly, the load delay analyzing means 125 may analyze the number of execution cycles required from starting execution of the spill-in instruction until completion of data reading, as the load processing time.

Thereafter, for each basic block satisfying the totally-anticipatability, the load delay analyzing means 125 generates LATᵢₙ(n) which is estimation of time when execution is stopped by the reading processing in the case of executing the spill-in instruction in the execution starting position of the basic block, and LATₒᵤₜ(n) which is estimation of time when execution is delayed by the reading processing in the case of executing the spill-in instruction in the execution ending position of the basic block.

Specifically, the load delay analyzing means 125 calculates LATᵢₙ(n) and LATₒᵤₜ(n) by the following equations (4). Here, SEC(n) represents estimation of the processing time for the entire nth block.

$$\begin{matrix}\text{[Equations 4]} \begin{matrix}{LAT}_{i n} ( n ) \text{:} = \{ \begin{matrix}LAT - LOC ( n ) & if GEN ( n ) \neq ϕ , \\ MAX ( 0 , {LAT}_{out} ( n ) - SEC ( ( n ) ) & if {ANT}_{i n} ( n ) \neq ϕ , \\ undefined & otherwise . \end{matrix} \\ {LAT}_{out} ( n ) \text{:} = \{ \begin{matrix}{MIN}_{m ∈ succ ( n )} {LAT}_{i n} ( m ) & if {ANT}_{out} ( n ) \neq ϕ , \\ undefined & otherwise . \end{matrix}\end{matrix} & ( 4 )\end{matrix}$$

As another example of calculation of LATout (n), the load delay analyzing means 125 may calculate the maximum value of LATᵢₙ(m) concerning an mth basic block, which can be executed subsequent to the nth block, as LAYₒᵤₜ(n). As still another example, the load delay analyzing means 125 may calculate LATin(m) concerning the mth basic block, which is judged to be most frequently executed among the basic blocks that can be executed subsequent to the nth basic block, as LAYₒᵤₜ(n)

Subsequently, for each basic block, the executable range generating means 120 generates DELAYEDᵢₙ(n) indicating whether or not the computational optimality concerning the computation e is satisfied when the spill-in instruction is executed in the execution starting position of the basic block, and DELAYEDₒᵤₜ(n) indicating whether or not the computational optimality concerning the computation e is satisfied when the spill-in instruction is executed in the execution ending position of the basic block.

Specifically, the executable range generating means generates DELAYEDᵢₙ(n) and DELAYEDₒᵤₜ(n) by the following equations (5).

$$[ \text{Equations 5} ] \\ {DELAYED}_{i n} ( n ) \text{:} = EAR - {ANT}_{i n} ( n ) ⋁ \{ \begin{matrix}false & if n is start . \\ {LAT}_{i n} ( n ) = 0 ⋀ {\prod }_{m ∈ pred ( n )} ( {DELAYED}_{out} ( m ) ⋀ \overline{{GEN}^{′} ( m )} ) & otheriwse .\end{matrix} {DELAYED}_{out} ( n ) \text{:} = EAR - {ANT}_{out} ( n ) ⋁ \\ ( {DELAYED}_{i n} ( n ) ⋀ GEN ( n ) = ) ϕ ⋀ {LAT}_{out} ( n ) = 0 ) \qquad ( 5 )$$

Thereafter, the executable range generating means 120 calculates a position, in the region satisfying the computational optimality, where an instruction is executed earlier by the time of delay in execution attributable to the reading processing than the execution position satisfying the lifetime optimality, as a generation position for generating the spill-in instruction. Specifically, the executable range generating means 120 generates LATESTᵢₙ(n) indicating whether or not the spill-in instruction is supposed to be generated in the execution starting position of the nth basic block, and LATESTₒᵤₜ(n) indicating whether or not the spill-in instruction is supposed to be generated in the execution ending position of the nth basic block, by use of the following equations (6).

$$\text{[Equations 6]} \\ {LATEST}_{i n} ( n ) \text{:} = {DELAYED}_{i n} ( n ) ⋀ ( GEN ( n ) \neq ϕ ⋁ {LAT}_{out} ( n ) > 0 ) \\ {LATEST}_{out} ( n ) \text{:} = {DELAYED}_{out} ( n ) ⋀ {\sum }_{m ∈ succ ( n )} \overline{{DELAYED}_{i n} ( m )} \qquad ( 6 )$$

In this way, the instruction generating means 150 can generate the precedent load instruction in the execution position where LATESTᵢₙ(n) or LATESTₒᵤₜ(n) is true, i.e. in the execution position where the instruction is executed earlier by the time obtained by subtracting the required processing time from the load processing time than the position satisfying the lifetime optimality.

Alternatively, instead of the processing from Steps S320 to Step S370, the optimizing compiler 10 may generate LATESTᵢₙ(n) or LATESTₒᵤₜ(n) by resolving the following equations (7), provided that the spill-in instruction does not cause exception.

$$\begin{matrix}\text{[Equations 7]} \begin{matrix}{ANT}_{i n} ( n ) \text{:} = \{ \begin{matrix}{ANT}_{out} ( n ) - KILL ( n ) & if {ANT}_{out} ( n ) - KILL ( n ) \neq ϕ , \\ GEN ( n ) & otherwise . \end{matrix} \\ {ANT}_{ out} ( n ) \text{:} = \{ \begin{matrix}ϕ & if n is end or ∀ ∈ succ ( n ) ( {ANT}_{i n} ( m ) = ϕ ) , \\ I {ANT}_{i n ( m )} & otherwise . \end{matrix}\end{matrix} m ∈ succ ( n ) ⋀ {ANT}_{i n} ( m ) \neq ϕ \\ EAR - {ANT}_{i n} ( n ) \text{:} = {ANT}_{i n} ( n ) \neq ϕ ⋀ {\sum }_{m ∈ pred ( n )} ( {ANT}_{out} ( m ) = ϕ \\ EAR - {ANT}_{out} ( n ) \text{:} = {ANT}_{out} ( n ) \neq ϕ ⋀ {ANT}_{out} ( n ) - KILL ( n ) = ϕ & ( 7 )\end{matrix}$$

According to this method, it is possible to delete more spill-in instructions and to shorten the time required for the compilation processing by omitting the processing for calculating availability.

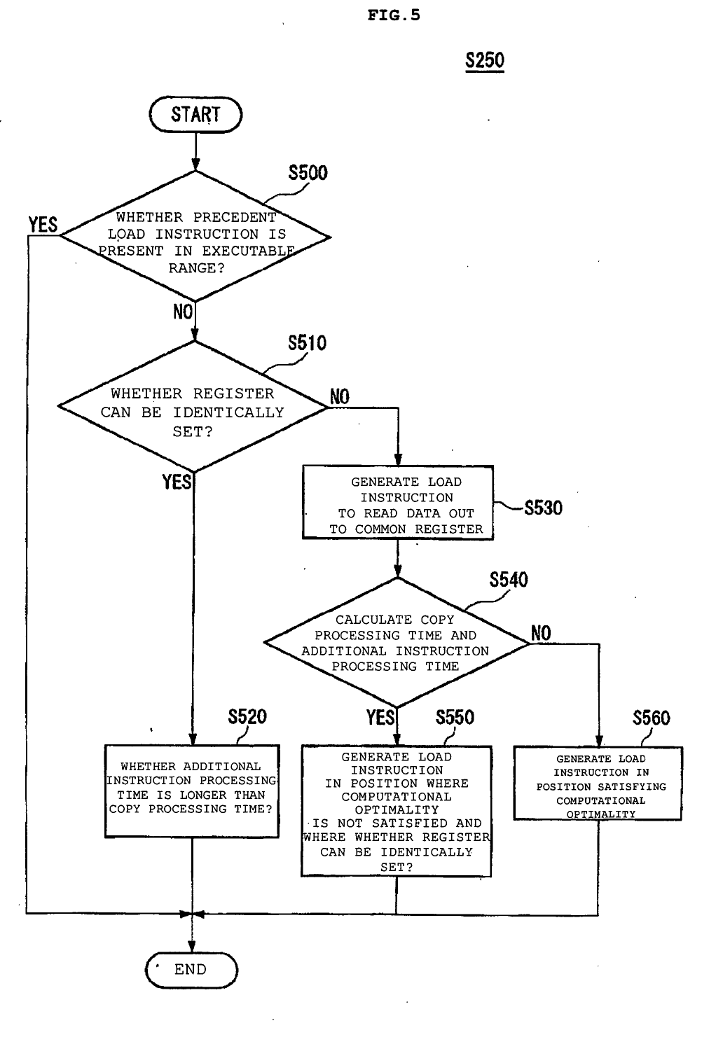

FIG. 5 is an operation flow showing details of S250 in FIG. 2. The instruction generating means 150 judges whether or not there is the precedent load instruction of the target spill-in instruction in the executable range of each execution path, by detecting whether or not there is the spill-in instruction in the basic block where LATESTᵢₙ(n) or LATESTₒᵤₜ(n) is true, for example (S500). When there is the precedent load instruction (S500: YES), the optimizing compiler 10 completes the processing in the drawing concerning the execution path.

When the computational optimality is satisfied, the identity judging means 130 judges whether or not it is possible to identically set the register as the reading targets of the precedent load instruction generated by the instruction generating means 150 and of all the other precedent load instructions. (S510).

For example, when the execution position of the precedent load instruction is represented by LATESTᵢₙ(n), the identity judging means 130 judges that it is possible to set one of registers in ANTᵢₙ(n) as the register of the reading target of the precedent load instruction. Meanwhile, when the execution position of the precedent load instruction is represented by LATESTₒᵤₜ(n), the identity judging means 130 judges that it is possible to set one of registers in ANTₒᵤₜ(n) as the register being the reading target of the precedent load instruction. Accordingly, the identity judging means 130 can check, on the plurality of precedent load instructions, whether or not it is possible to identically set the register as the reading target, by judging whether or not a set of registers settable as the reading targets overlap one another.

When the identity judging means 130 judges that it is possible to identically set the register (S510: YES), the instruction generating means 150 generates the precedent load instruction which read the data into the common register identical to other precedent load instructions in the position satisfying the computational optimality and the lifetime optimality, such as the position where LATESTᵢₙ(n) or LATESTₒᵤₜ(n) is true (S520).

On the contrary, when the identity judging means 130 judges that it is not possible to identically set the register (S510: NO), the copy processing time calculating means 140 calculates the copy processing time required for copying the data among the registers in the case of not setting the register identically, and the additional instruction processing time which is the processing time for the additional load instruction in comparison with the case of satisfying the computational optimality when setting the register identically (S530).

When the additional instruction processing time calculated by the copy processing time calculating means 140 is longer than the copy processing time (S540: YES), the instruction generating means 150 generates the precedent load instruction in a position in the executable range where the computational optimality is not satisfied and where it is possible to identically set the register as the reading targets of the respective precedent load instructions, such as a downstream junction which is an execution position to be executed after the plurality of precedent load instructions, where control flows merge together (S550).

When the additional instruction processing time calculated by the copy processing time calculating means 140 is shorter than the copy processing time (S540: NO), the instruction generating means 150 generates the precedent load instruction in a position where the computational optimality is satisfied, such as the position where LATESTᵢₙ(n) or LATESTₒᵤₜ(n) is true (S560).

Note that, the optimizing compiler 10 may repeat the processing shown in this drawing in order to generate the precedent load instructions in the executable ranges of the plurality of execution paths.

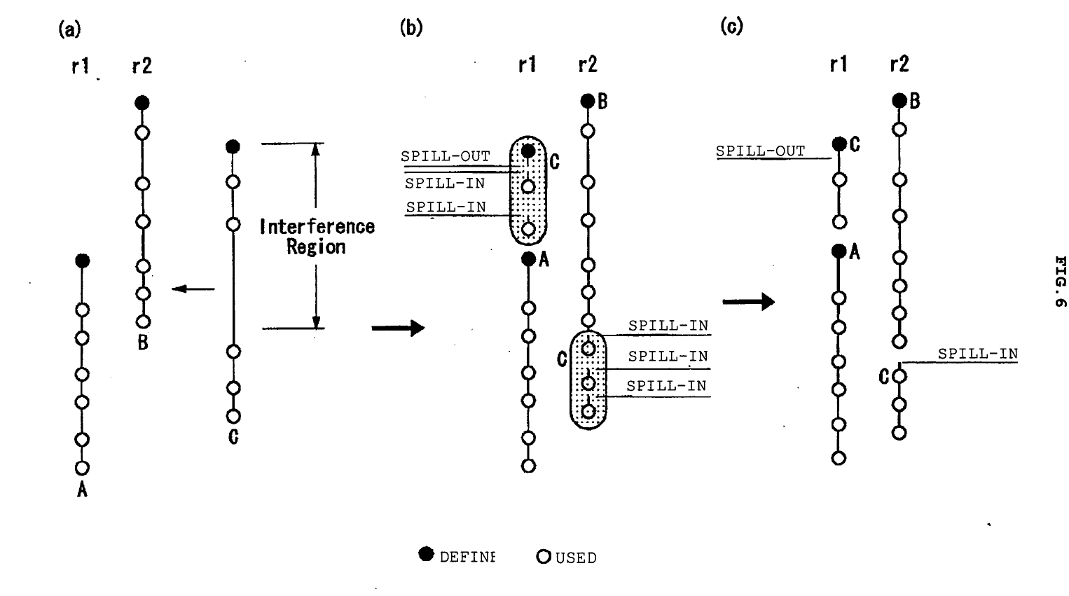

FIGS. 6A to 6C show a first application example of this embodiment. These drawings show an example of allocating a variable A, a variable B, and a variable C to a register r1 and a reregister r2. In these drawings, a direction of execution of a target program is downward. Moreover, black dots show instructions to define variable values, and white dots show instructions to use the variable values. Meanwhile, solid lines connecting the respective dots show ranges where the variable values are effectively held in the registers.

FIG. 6A shows an example of the target program in which the variables are allocated to the registers by the register allocating means 100. A lifetime of the variable B overlaps a lifetime of the variable C in an interference region illustrated therein. For example, when the register allocation processing is performed in accordance with the technique disclosed in Non-patent document 5, the register allocating means 100 allocates the variable A and the variable B to the register r1 and the register r2, respectively, and judges that the variable C is unallocatable to the registers.

FIG. 6B shows an example of the target program where spill-in instructions are generated by the spill-in instruction generating means 10. The spill-in instruction generating means 110 generates a spill-out instruction to store data indicating a value of the variable C into a memory when the value of the variable C is defined, and generates a spill-in instruction to read the data from the memory into the register r1 or the register r2 every time when the variable C is used.

FIG. 6C shows a resultant program which is a result of optimization by the optimizing compiler 10 according to this embodiment. As shown in the drawing, the optimizing compiler 10 can hold the value of the variable C into the usable register even when the variables are allocated to the registers by the register allocating means 100. In this way, it is possible to reduce the frequency of execution of the spill-in instructions and thereby to increase the entire processing speed.

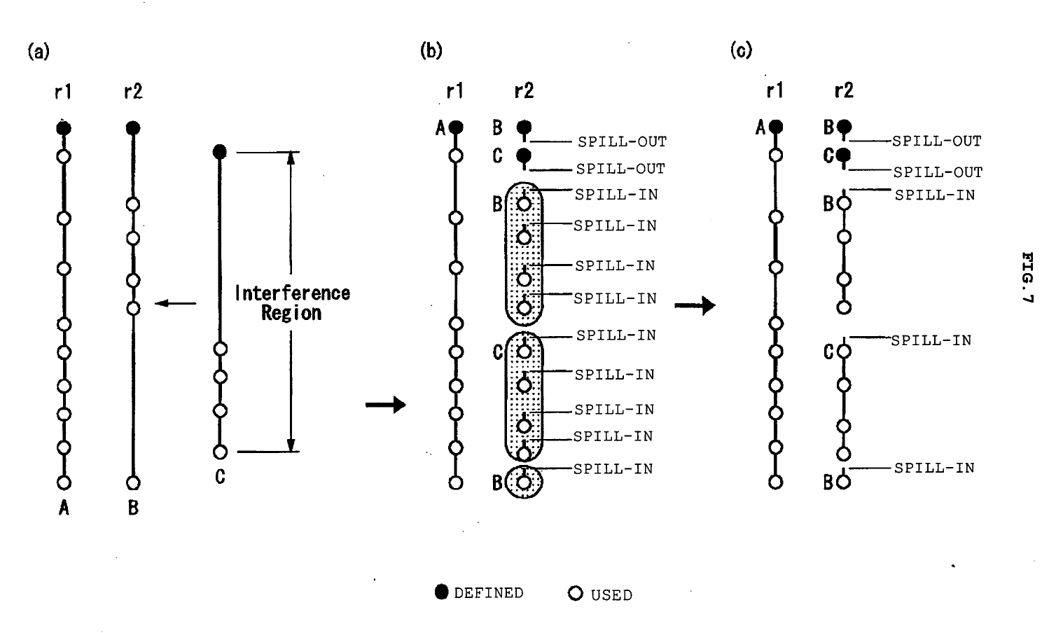

FIGS. 7A to 7C show a second application example of this embodiment. FIG. 7A shows an example of a target program in which variables are allocated to registers by the register allocating means 100. The lifetime of the variable B overlaps the lifetime of the variable C in an interference region illustrated therein. Here, the register allocating means 100 allocates the variable A to the register r1, and judges that the variable B and the variable C are unallocatable to the registers.

FIG. 7B shows an example of the target program where spill-in instructions are generated by the spill-in instruction generating means 110. The spill-in instruction generating means 110 generates a spill-out instruction to store data indicating a value of the variable B into the memory when the value of the variable B is defined, and generates a spill-in instruction to read the data from the memory into the register r2 every time when the variable B is used. In the meantime, the spill-in instruction generating means 110 generates a spill-out instruction to store data indicating a value of the variable C into the memory when the value of the variable C is defined, and generates a spill-in instruction to read the data from the memory into the register r2 every time when the variable C is used.

FIG. 7C shows a resultant program which is a result of optimization by the optimizing compiler 10 according to this embodiment. As shown in the drawing, the optimizing compiler 10 can hold the value of either the variable B or the variable C into the still usable register r2 even when the variables are allocated to the registers by the register allocating means 100. In this way, it is possible to reduce the frequency of execution of the spill-in instructions and thereby to increase the entire processing speed.

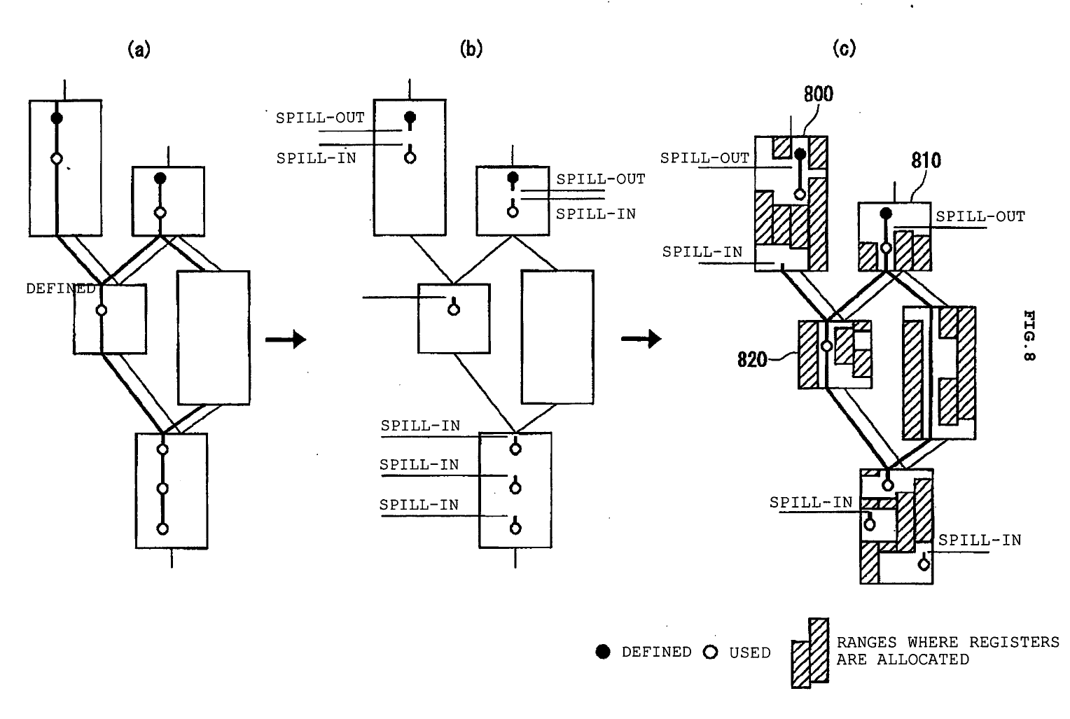

FIGS. 8A to 8C show a third application example of this embodiment. FIG. 8A shows an example of a target program prior to optimization. In this drawing, definitions of values concerning variables judged as unallocatable to a register by the register allocating means 100 are indicated with black dots, and the use of the values concerning the valuable is indicated with white dots. Moreover, lifetimes of the variable values are indicated with solid bold lines.

FIG. 8B shows an example of the target program where spill-in instructions are generated by the spill-in instruction generating means 110. In terms of the variable judged as unallocatable to the register by the register allocating means 100, the spill-in instruction generating means 110 generates a spill-out instruction to store the variable value into the memory every time when the variable value is defined, and generates a spill-in instruction to load the variable value from the memory prior to each instruction using the value every time when the variable value is used.

FIG. 8C shows a resultant program which is a result of optimization by the optimizing compiler 10 according to this embodiment. This drawing shows a case where the register allocating means 100 allocates the variables to four registers, and shaded portions in the drawing indicate ranges where the registers have been already allocated to the variables by the register allocating means 100.

For example, optimizing compiler 10 checks, whether there is a precedent load instruction in an executable range, on a basic block 800 and a basic block 810 reachable by tracing back execution procedures from the spill-in instruction in a basic block 820. Since there is not a precedent load instruction in the basic block 800, the optimizing compiler 10 generates a spill-in instruction in the basic block 800, which is a precedent load instruction. In this way, the optimizing compiler 10 can delete the spill-in instruction in the basic block 820.

Accordingly, the optimizing compiler 10 can hold the variable values in the still usable registers even when the variables are allocated to the registers by the register allocating means 100. In this way, it is possible to reduce the frequency of execution of the spill-in instructions and thereby to increase the entire processing speed.

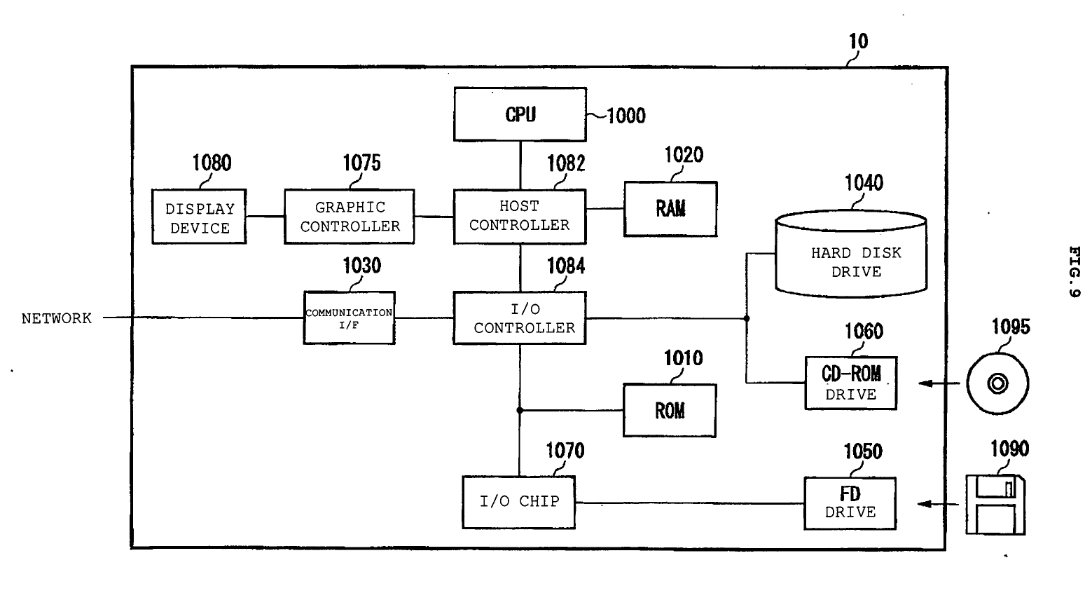

FIG. 9 shows an example of a hardware configuration of a computer functioning as the optimizing compiler 10. The optimizing compiler 10 includes: a CPU peripheral unit having CPU 1000, a RAM 1020, a graphic controller 1075, and a display device 1080 which are connected to one another with a host controller 1082; an input/output unit having a communication interface 1030, a hard disk drive 1040, and a CD-ROM drive 1060 which are connected to the host controller 1082 with an input/output controller 1084; and a legacy input/output unit having a ROM 1010, a flexible disk drive 1050, and an input/output chip 1070 which are connected to the input/output controller 1084.

The host controller 1082 connects the RAM 1020, the CPU 1000 accessing the RAM 1020 at a high transfer rate, and the graphic controller 1075 thereto. The CPU 1000 operates based on programs stored in the ROM 1010 and the RAM 1020 to control the respective units. The graphic controller 1075 acquires image data generated by the CPU 1000 and the like on a frame buffer provided in the RAM 1020, and displays the image data on the display device 1080. Instead, the graphic controller 1075 may incorporate the frame buffer for storing the image data generated by the CPU 1000 and the like.

The input/output controller 1084 connects the host controller 1082, the communication interface 1030 which is a relatively high-speed input/output device, the hard disk drive 1040, and the CD-ROM drive 1060 thereto. The communication interface 1030 communicates with an external device through a network such as a fiber channel. The hard disk drive 1040 stores a compiler program and data used by the optimizing compiler 10. The CD-ROM drive 1060 reads the compiler program or the data from a CD-ROM 1095 and provides the compiler program and the data to the input/output chip 1070 through the RAM 1020.

Meanwhile, the ROM 1010, and relatively low-speed input/output devices such as the flexible disk drive 1050 and the input/output chip 1070 are connected to the input/output controller 1084. The ROM 1010 stores a boot program executed by the CPU 1000 when starting the optimizing compiler 10, a program depending on the hardware of the optimizing compiler 10, and the like. The flexible disk drive 1050 read the compiler program or the data from a flexible disk 1090 and provides the compiler program or the data to the input/output chip 1070 through the RAM 1020. The input/output chip 1070 connects various input/output devices through a flexible disk 1090, a parallel port, a serial port, a keyboard port, a mouse port or the like, for example.

The compiler program provided to the optimizing compiler 10 is stored in a recording medium such as the flexible disk 1090, the CD-ROM 1095 or an IC card, and is provided by a user. The compiler program is read from the recording medium through the input/output chip 1070 and/or the input/output controller 1084, installed in the optimizing compiler 10 and then executed.

The compiler program to be installed in and executed by the optimizing compiler 10 includes a register allocation module, a spill-in instruction generation module, an executable range detection module, an identity judgment module, a copy processing time calculation module, an other instruction processing time analysis module, an instruction generation module, an instruction replacement module, and a store instruction deletion module. Operations which the respective modules cause the optimizing compiler 10 to perform are identical to the operations of the corresponding members in the optimizing compiler 10 described in FIG. 1 to FIG. 8C. Accordingly, duplicate explanation will be omitted herein.

The above-described compiler program or modules may be stored in an external storage medium. In addition to the flexible disk 1090 and the CD-ROM 1095, it is possible to use an optical recording medium such as a DVD or a PD, a magnetooptical recording medium such as an MD, a tape medium, a semiconductor memory such as an IC card, and the like as the storage medium. Alternatively, it is possible to provide the compiler program to the optimizing compiler 10 through a network while using a storage medium such as a hard disk or a RAM, as the recording medium, provided in a server system connected to a private communication network or the Internet.

As it is apparent from the foregoing description, the optimizing compiler 10 can hold the variable value in the still usable register even when the variable is allocated to the register by the register allocating means 100. In this way, it is possible to reduce the frequency of execution of the spill-in instructions and thereby to increase the entire processing speed.

Although the present invention has been described by use of a certain embodiment, the technical scope of the present invention shall riot be limited to those described in the embodiment. It is apparent to those skilled in the art that various modifications and improvements can be added to the above-described embodiment. It is apparent from the appended claims that such aspects after modifications or improvements can be also included in the technical scope of the present invention.

As it is apparent from the description above, this example embodiment achieves the optimizing compiler, the compiling method, the compiler program, and the recording medium as described in the respective items below.

(Item 1) An optimizing compiler for optimizing a load instruction to read data from a memory into a register in a target program targeted for optimization, including: executable range detecting means for detecting an executable range of a load instruction in each of all execution paths reachable by tracing back execution procedures from a target load instruction targeted for optimization in the target program, the executable range being capable of holding the data read by the load instruction into the register and transmitting the data to an execution position of the target load instruction when the load instruction is executed; instruction generating means for generating a precedent load instruction, which is to be executed prior to the target load instruction in the executable range, within the executable range for each of the execution paths when the precedent load instruction for reading the same data from the same address as that of the target load instruction is absent; and instruction replacing means for deleting the target load instruction and replacing an instruction using the data read by the target load instruction with an instruction using data which are read by the precedent load instruction, held in the register, and propagated therefrom.

(Item 2) The optimizing compiler according to Item 1, further including: register allocating means for allocating a variable to the register; and spill-in instruction generating means for generating a spill-in instruction to load a value of the variable from the memory prior to each instruction using the value of the variable for each variable judged as unallocatable to the register by the register allocating means, wherein the executable range detecting means detects the executable range in each of all execution paths reachable by tracing back a target spill-in instruction while defining the spill-in instruction as the target spill-in instruction which is the target load instruction, the instruction generating means generates the precedent load instruction in the executable range for each of the execution paths when the precedent load instruction concerning the target spill-in instruction is absent in the executable range, and the instruction replacing means deletes the target spill-in instruction and replaces an instruction using the data read by the target spill-in instruction with an instruction using the data to be read by the precedent load instruction, to be held in the register, and to be propagated therefrom.

(Item 3) The optimizing compiler according to Item 1, wherein the executable range detecting means detects the executable ranges in the plurality of execution paths concerning each of the plurality of target load instructions for mutually reading the same data from the same address, the instruction generating means, for each of the execution paths for a first target load instruction, generates the precedent load instruction in an overlapped range when the executable range does not exist in the executable range and when the executable range and at least part of an executable range in a second target load instruction overlap each other, and the instruction replacing means deletes each of the target load instruction being determined to be executed after the precedent load instruction and existing in the executable range, and replaces the instruction using the data read by the target load instruction with the instruction using the data to be read by the precedent load instruction, to be stored in the register, and to be propagated therefrom.

(Item 4) The optimizing compiler according to Item 3, wherein the instruction generating means, for a plurality of target load instruction having any of the executable ranges overlapping each other, generates the precedent load instruction in a range satisfying computational optimality concerning the plurality of target load instructions.

(Item 5) The optimizing compiler according to Item 4, further including: identity judging means for judging whether it is possible to identically set a register as reading targets of the precedent load instruction generated by the instruction generating means and of other precedent load instructions in the case where the computational optimality is retained, wherein the instruction generating means generates the precedent load instruction in a position in the executable range where the computational optimality is not satisfied and where it is possible to identically set the register as the reading targets of the precedent load instruction and of the other precedent load instructions when it is not possible to identically set the register.

(Item 6) The optimizing compiler according to Item 5, further including: copy processing time calculating means for calculating, when the identity judging means judges that it is not possible to identically set the register, copy processing time required for copying the data among the registers in a case of not setting the register identically, and additional instruction processing time being processing time for an additional load instruction in comparison with a case of satisfying the computational optimality when setting the register identically, wherein the instruction generating means generates the precedent load instruction in the position where the computational optimality is not satisfied and where it is possible to identically set the register as the reading targets of the precedent load instruction and of the other precedent load instructions, provided that the additional instruction processing time is longer than the copy processing time.

(Item 7) The optimizing compiler according to Item 4, wherein the instruction generating means generates the precedent load instruction in a position in a range satisfying the computational optimality and further satisfying lifetime optimality, where a lifetime of the data read by the precedent load instruction becomes smallest.

(Item 8) The optimizing compiler according to Item 7, further including: load delay analyzing means for analyzing required processing time being processing time required for executing another instruction from a position satisfying the lifetime optimality to an execution position of the instruction using the data to be read by the precedent load instruction, and load processing time required from starting execution of the precedent load instruction until completion of reading the data, wherein the instruction generating means, when the required processing time is shorter than the load processing time, generates the precedent load instruction in a position executed prior to the position satisfying the lifetime optimality.

(Item 9) The optimizing compiler according to Item 8, wherein the instruction generating means, when the required processing time is shorter than load processing time, generates the precedent load instruction in an execution position executed prior to the position satisfying the lifetime optimality by time calculated by subtracting the required processing time from the load processing time.

(Item 10) The optimizing compiler according to Item 1, wherein the order generating means, when the precedent load instruction is absent in the executable range in each of the execution paths as the precedent load instruction, generates a load instruction to read the data into a common register being identical to a register where the data to be read by another precedent load instruction, and the instruction replacing means replaces the instruction using the data read by the target load instruction with an instruction using the data held in the common register.

(Item 11) The optimizing compiler according to Item 1, further including: store instruction deleting means for deleting, when the target load instruction is deleted by the instruction deleting means, a store instruction for writing data which are read only by the target load instruction and are not read by the generated precedent load instruction.

(Item 12) An optimizing compiler for optimizing a load instruction to read data from a memory into a register in a target program targeted for optimization, including: executable range detecting means for detecting an executable range of a load instruction in each of all execution paths reachable by tracing back execution procedures from a target load instruction targeted for optimization in the target program, the executable range being capable of holding the data read by the load instruction into the register and transmitting the data to an execution position of the target load instruction when the load instruction is executed; and instruction replacing means for deleting the target load instruction and replacing an instruction using the data read by the target load instruction with an instruction using data which are read by a precedent load instruction, held in the register, and propagated therefrom, when the precedent load instruction for reading the same data from the same address as that of the target load instruction is present.

(Item 13) A compiling method for optimizing a load instruction to read data from a memory into a register in a target program targeted for optimization, including: an executable range detecting step of detecting an executable range of a load instruction in each of all execution paths reachable by tracing back execution procedures from a target load instruction targeted for optimization in the target program, the executable range being capable of holding the data read by the load instruction into the register and transmitting the data to an execution position of the target load instruction when the load instruction is executed; an instruction generating step of generating a precedent load instruction, which is to be executed prior to the target load instruction in the executable range, within the executable range for each of the execution paths when the precedent load instruction for reading the same data from the same address as that of the target load instruction is absent; and an instruction replacing step of deleting the target load instruction and replacing an instruction using the data read by the target load instruction with an instruction using data which are read by the precedent load instruction, held in the register, and propagated therefrom.

(Item 14) A compiler program for causing a computer to function as an optimizing compiler for optimizing a load instruction to read data from a memory into a register in a target program targeted for optimization, the compiler program causing the computer to execute the functions of: executable range detecting means for detecting an executable range of a load instruction in each of all execution paths reachable by tracing back execution procedures from a target load instruction targeted for optimization in the target program, the executable range being capable of holding the data read by the load instruction into the register and transmitting the data to an execution position of the target load instruction when the load instruction is executed; instruction generating means for generating a precedent load instruction, which is to be executed prior to the target load instruction in the executable range, within the executable range for each of the execution paths when the precedent load instruction for reading the same data from the same address as that of the target load instruction is absent; and instruction replacing means for deleting the target load instruction and replacing an instruction using the data read by the target load instruction with an instruction using data which are read by the precedent load instruction, held in the register, and propagated therefrom.

(Item 15) A recording medium recording the compiler program according to Item 14.

Although the advantageous embodiments of the present invention has been described in detail, it should be understood that various changes, substitutions and alternations can be made therein without departing from spirit and scope of the invention as defined by the appended claims.

Note that the above-described outline of the invention does not enumerate all necessary characteristics of the present invention, and that of a group of the characteristics also constitute the present invention. Thus, according to the present invention, it is possible to make reference to variable values efficiently.

The present invention can be realized in hardware, software, or a combination of hardware and software. The present invention can be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after conversion to another language, code or notation and/or reproduction in a different material form.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that other modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. An optimizing compiler for optimizing a load instruction to read data from a memory into a register in a target program targeted for optimization, comprising:
executable range detecting means for detecting an executable range of a load instruction in each of all execution paths reachable by tracing back execution procedures from a target load instruction targeted for optimization in the target program, the executable range being capable of holding the data read by the load instruction into the register and transmitting the data to an execution position of the target load instruction when the load instruction is executed;
instruction generating means for generating a precedent load instruction, which is to be executed prior to the target load instruction in the executable range, within the executable range for each of the execution paths when the precedent load instruction for reading the same data from the same address as that of the target load instruction is absent; and
instruction replacing means for deleting the target load instruction and replacing an instruction using the data read by the target load instruction with an instruction using data which are read by the precedent load instruction, held in the register, and propagated therefrom.

2. The optimizing compiler according to claim 1, further comprising:
register allocating means for allocating a variable to the register; and
spill-in instruction generating means for generating a spill-in instruction to load a value of the variable from the memory prior to each instruction using the value of the variable for each variable judged as unallocatable to the register by the register allocating means,
wherein the executable range detecting means detects the executable range in each of all execution paths reachable by tracing back a target spill-in instruction while defining the spill-in instruction as the target spill-in instruction which is the target load instruction,
the instruction generating means generates the precedent load instruction in the executable range for each of the execution paths when the precedent load instruction concerning the target spill-in instruction is absent in the executable range, and
the instruction replacing means deletes the target spill-in instruction and replaces an instruction using the data read by the target spill-in instruction with an instruction using the data to be read by the precedent load instruction, to be held in the register, and to be propagated therefrom.

3. The optimizing compiler according to claim 1,
wherein the executable range detecting means detects the executable ranges in the plurality of execution paths concerning each of the plurality of target load instructions for mutually reading the same data from the same address,
the instruction generating means, for each of the execution paths for a first target load instruction, generates the precedent load instruction in an overlapped range when the executable range does not exist in the executable range and when the executable range and at least part of an executable range in a second target load instruction overlap each other, and
the instruction replacing means deletes each of the target load instruction being determined to be executed after the precedent load instruction and existing in the executable range, and replaces the instruction using the data read by the target load instruction with the instruction using the data to be read by the precedent load instruction, to be stored in the register and to be propagated therefrom.

4. The optimizing compiler according to claim 3,
wherein the instruction generating means, for a plurality of target load instruction having any of the executable ranges overlapping each other, generates the precedent load instruction in a range satisfying computational optimality concerning the plurality of target load instructions.

5. The optimizing compiler according to claim 4, further comprising:
identity judging means for judging whether it is possible to identically set a register as reading targets of the precedent load instruction generated by the instruction generating means and of other precedent load instructions in the case where the computational optimality is retained,
wherein the instruction generating means generates the precedent load instruction in a position in the executable range where the computational optimality is not satisfied and where it is possible to identically set the register as the reading targets of the precedent load instruction and of the other precedent load instructions when it is not possible to identically set the register.

6. The optimizing compiler according to claim 5, further comprising:
copy processing time calculating means for calculating, when the identity judging means judges that it is not possible to identically set the register, copy processing time required for copying the data among the registers in a case of not setting the register identically, and additional instruction processing time being processing time for an additional load instruction in comparison with a case of satisfying the computational optimality when setting the register identically,
wherein the instruction generating means generates the precedent load instruction in the position where the computational optimality is not satisfied and where it is possible to identically set the register as the reading targets of the precedent load instruction and of the other precedent load instructions, provided that the additional instruction processing time is longer than the copy processing time.

7. The optimizing compiler according to claim 4,
wherein the instruction generating means generates the precedent load instruction in a position in a range satisfying the computational optimality and further satisfying lifetime optimality, where a lifetime of the data read by the precedent load instruction becomes smallest.

8. The optimizing compiler according to claim 7, further comprising:
load delay analyzing means for analyzing required processing time being processing time required for executing another instruction from a position satisfying the lifetime optimality to an execution position of the instruction using the data to be read by the precedent load instruction, and load processing time required from starting execution of the precedent load instruction until completion of reading the data,
wherein the instruction generating means, when the required processing time is shorter than the load processing time, generates the precedent load instruction in a position executed prior to the position satisfying the lifetime optimality.

9. The optimizing compiler according to claim 8,
wherein the instruction generating means, when the required processing time is shorter than load processing time, generates the precedent load instruction in an execution position executed prior to the position satisfying the lifetime optimality by time calculated by subtracting the required processing time from the load processing time.

10. The optimizing compiler according to claim 1,
wherein the order generating means, when the precedent load instruction is absent in the executable range in each of the execution paths as the precedent load instruction, generates a load instruction to read the data into a common register being identical to a register where the data to be read by another precedent load instruction, and
the instruction replacing means replaces the instruction using the data read by the target load instruction with an instruction using the data held in the common register.

11. The optimizing compiler according to claim 1, further comprising:
store instruction deleting means for deleting, when the target load instruction is deleted by the instruction deleting means, a store instruction for writing data which are read only by the target load instruction and are not read by the generated precedent load instruction.

12. An optimizing compiler for optimizing a load instruction to read data from a memory into a register in a target program targeted for optimization, comprising:
executable range detecting means for detecting an executable range of a load instruction in each of all execution paths reachable by tracing back execution procedures from a target load instruction targeted for optimization in the target program, the executable range being capable of holding the data read by the load instruction into the register and transmitting the data to an execution position of the target load instruction when the load instruction is executed; and
instruction replacing means for deleting the target load instruction and replacing an instruction using the data read by the target load instruction with an instruction using data which are read by a precedent load instruction, held in the register, and propagated therefrom, when the precedent load instruction for reading the same data from the same address as that of the target load instruction is present.

13. A compiling method for optimizing a load instruction to read data from a memory into a register in a target program targeted for optimization, comprising the steps of:
detecting an executable range of a load instruction in each of all execution paths reachable by tracing back execution procedures from a target load instruction targeted for optimization in the target program, the executable range being capable of holding the data read by the load instruction into the register and transmitting the data to an execution position of the target load instruction when the load instruction is executed;
generating a precedent load instruction, which is to be executed prior to the target load instruction in the executable range, within the executable range in each of the execution paths when the precedent load instruction for reading the same data from the same address as that of the target load instruction is absent; and
deleting the target load instruction and replacing an instruction using the data read by the target load instruction with an instruction using data which are read by the precedent load instruction, held in the register, and propagated therefrom.

14. A compiler program for causing a computer to function as an optimizing compiler for optimizing a load instruction to read data from a memory into a register in a target program targeted for optimization, the compiler program causing the computer to execute the functions of:
executable range detecting means for detecting an executable range of a load instruction in each of all execution paths reachable by tracing back execution procedures from a target load instruction targeted for optimization in the target program, the executable range being capable of holding the data read by the load instruction into the register and transmitting the data to an execution position of the target load instruction when the load instruction is executed;
instruction generating means for generating a precedent load instruction, which is to be executed prior to the target load instruction in the executable range, within the executable range for each of the execution paths when the precedent load instruction for reading the same data from the same address as that of the target load instruction is absent; and
instruction replacing means for deleting the target load instruction and replacing an instruction using the data read by the target load instruction with an instruction using data which are read by the precedent load instruction, held in the register, and propagated therefrom.

15. A recording medium recording the compiler program according to claim 14.

16. A computer program product comprising a computer usable medium having computer readable program code means embodied therein for causing optimization of a load instruction to read data from a memory into a register in a target program targeted for optimization, the computer readable program code means in said computer program product comprising computer readable program code means for causing a computer to effect:
executable range detecting means for detecting an executable range of a load instruction in each of all execution paths reachable by tracing back execution procedures from a target load instruction targeted for optimization in the target program, the executable range being capable of holding the data read by the load instruction into the register and transmitting the data to an execution position of the target load instruction when the load instruction is executed;
instruction generating means for generating a precedent load instruction, which is to be executed prior to the target load instruction in the executable range, within the executable range for each of the execution paths when the precedent load instruction for reading the same data from the same address as that of the target load instruction is absent; and
instruction replacing means for deleting the target load instruction and replacing an instruction using the data read by the target load instruction with an instruction using data which are read by the precedent load instruction, held in the register, and propagated therefrom.

17. A computer program product as recited in claim 16, further comprising computer readable program code means for causing a computer to effect:
register allocating means for allocating a variable to the register; and
spill-in instruction generating means for generating a spill-in instruction to load a value of the variable from the memory prior to each instruction using the value of the variable for each variable judged as unallocatable to the register by the register allocating means,
wherein the executable range detecting means detects the executable range in each of all execution paths reachable by tracing back a target spill-in instruction while defining the spill-in instruction as the target spill-in instruction which is the target load instruction,
the instruction generating means generates the precedent load instruction in the executable range for each of the execution paths when the precedent load instruction concerning the target spill-in instruction is absent in the executable range, and
the instruction replacing means deletes the target spill-in instruction and replaces an instruction using the data read by the target spill-in instruction with an instruction using the data to be read by the precedent load instruction, to be held in the register, and to be propagated therefrom.

18. A computer program product as recited in claim 16,
wherein the executable range detecting means detects the executable ranges in the plurality of execution paths concerning each of the plurality of target load instructions for mutually reading the same data from the same address,
the instruction generating means, for each of the execution paths for a first target load instruction, generates the precedent load instruction in an overlapped range when the executable range does not exist in the executable range and when the executable range and at least part of an executable range in a second target load instruction overlap each other, and
the instruction replacing means deletes each of the target load instruction being determined to be executed after the precedent load instruction and existing in the executable range, and replaces the instruction using the data read by the target load instruction with the instruction using the data to be read by the precedent load instruction, to be stored in the register and to be propagated therefrom.

19. A computer program product as recited in claim 16, further comprising computer readable program code means for causing a computer to effect:
store instruction deleting means for deleting, when the target load instruction is deleted by the instruction deleting means, a store instruction for writing data which are read only by the target load instruction and are not read by the generated precedent load instruction.

20. An article of manufacture comprising a computer usable medium having computer readable program code means embodied therein for causing optimization of a load instruction to read data from a memory into a register in a target program targeted for optimization, the computer readable program code means in said article of manufacture comprising computer readable program code means for causing a computer to effect the steps of:
detecting an executable range of a load instruction in each of all execution paths reachable by tracing back execution procedures from a target load instruction targeted for optimization in the target program, the executable range being capable of holding the data read by the load instruction into the register and transmitting the data to an execution position of the target load instruction when the load instruction is executed;
generating a precedent load instruction, which is to be executed prior to the target load instruction in the executable range, within the executable range in each of the execution paths when the precedent load instruction for reading the same data from the same address as that of the target load instruction is absent; and
deleting the target load instruction and replacing an instruction using the data read by the target load instruction with an instruction using data which are read by the precedent load instruction, held in the register, and propagated therefrom.
